(19) United States
(12) Patent Application Publication
(10) Pub. No.: US 2004/0240012 A1
(43) Pub. Date: Dec. 2, 2004

(54) Hologram recording method and hologram recording apparatus

(75) Inventors: Shin Yasuda, Ashigarakami-gun (JP); Jiro Minabe, Ashigarakami-gun (JP); Katsunori Kawano, Ashigarakami-gun (JP); Tatsuya Maruyama, Minato-ku (JP); Norie Matsui, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/808,372

(22) Filed: Mar. 25, 2004

(30) Foreign Application Priority Data
May 26, 2003 (JP) 2003-147489

(51) Int. Cl. G03H 1/04; G11B 7/00

(52) U.S. Cl. 359/24; 430/1; 430/2; 359/35

(57) ABSTRACT

Quality of a reproduced light beam is improved, and rewriting and recording are performed at high speed without erasing data. Each page of a hologram is newly recorded so that the maximum point of diffraction light beam intensity in reproducing the newly recorded hologram is located at a position where diffraction light beam intensity from a data page of a hologram which has been previously recorded in a hologram recording medium is minimized at the time of reproducing the data.

### CROSS-REFERENCE TO RELATED APPLICATION

This application claims priority under 35 USC 119 from Japanese Patent Application No. 2003-147489, the disclosure of which is incorporated by reference herein.

### BACKGROUND OF THE INVENTION

1. Field of the Invention

The present invention relates to a hologram recording method and a hologram recording apparatus, and particularly to a hologram recording method and a hologram recording apparatus for overwriting and recording data in a hologram recording medium for holographic storage, especially for digital holographic storage.

2. Description of the Related Art

An optical memory, of which a DVD is representative, is widely used as the memory capable of realizing large capacity and high density. In order to achieve much larger capacity of the optical memory, research and development on an optical memory using a blue-violet laser as a light source is now actively being carried out.

Heretofore an increase in the density of the optical memory has been realized in such a manner that a laser spot used for recording and reproducing data is reduced by shortening a wavelength of a light beam to be used and by increasing NA. Since there is no optical material that is appropriate for the region of ultraviolet rays, and therefore, since there exists no proper optical material to be used for a recording medium, lens, and the like, it is considered that the use of blue-violet lasers is the limit of the method of shortening the wavelength of the light beam and that it will be difficult to further shorten the wavelength.

On the other hand, as a method for increasing NA, a method has been proposed, in which a numerical aperture is increased by a refractive index of a prism with a SIL (Solid Immersion Lens) for decreasing a condensed spot by using a circular prism having a high refractive index. In this method, it is necessary to make a distance between a bottom surface of the prism and a recording medium small enough to form a minute condensing spot by utilizing an evanescent wave formed on the bottom surface of the prism. Therefore, there are problems such as control of the distance between the prism and a substrate, and establishment of portability of an optical disk. Further, the refractive index of a prism material is about 2 at most, and therefore, the increase in the recording density is about four times at most. In order to record in the optical disk at a recording capacity of 50 GB or more, a volume type memory in which recording can also be performed in a depth direction of a recording medium is required.

The holographic memory is known as one kind of volume type memory. The holographic memory can perform large capacity recording due to the use of a three-dimensional recording region, and can also perform high-speed recording because the holographic memory adopts a two-dimensional batch recording and processing method. In this method, data having a plurality of pages can be recorded with the plurality of pages multiplexed within the same volume, and the data can be read out one page at a time.

In addition to analog images, recording and reproducing of digital information can also be achieved by digitalizing binary digital data of “0” and “1” into “bright and dark” and performing hologram recording and reproducing. In recent years, research is proceeding from a more engineering-based point of view, such as proposals of an SN ratio and bit error rate evaluation, and two-dimensional coding on the basis of a specific optical system or a volume multiple recording method of the digital holographic memory, and influence of aberration of the optical system.

FIG. 6 is a view explaining an angular multiplexing method which is one of the hologram multiplexing methods. In the case of the angular multiplexing method, the hologram is recorded in such a manner that a digital data page (signal light beam) 2 is condensed by a lens 4 and the same volume within a hologram recording medium 6 is simultaneously irradiated with a reference light beam and the signal light beam. In the case of the multiple recording, the signal light beam is recorded by changing an incident angle of the reference light beam. In reading out the data (reproducing), the objective hologram is accessed by addressing the data with the reference light beam used for the recording, and the data page can be reproduced.

FIGS. 7A and 7B are a view explaining a shift multiplexing method. In this method, a light wave whose wavefront is rapidly changed, such as a spherical wave and a speckle pattern, is used as the reference light beam. In the case where such a reference light is used, Bragg condition for the reproducing can be avoided only by slightly shifting a position of the recording medium by the amount of shift δ from the recording spot (FIG. 7B), and the new hologram can be recorded there. That is to say, the multiple recording of the hologram can be performed in substantially the same volume by recording while slightly shifting the recording medium.

A wavelength multiplexing method is also known, in which an angle formed between the signal light beam and the reference light beam is made at a constant value, the recording medium is simultaneously irradiated with the signal light beam and the reference light beam while changing the wavelengths of the signal light beam and the reference light beam, and information of the signal light beam is multiple-recorded as the hologram of the plurality of pages in the recording medium. In this method, there is a wavelength at which the information of the signal light beam is not reproduced when the wavelength of the reference light beam is changed in reproducing the hologram of one page. The new hologram can be recorded in the same position of the recording medium by using the signal light beam and the reference light beam having the above wavelengths. Thus, the plurality of holograms can be multiple-recorded in the same position of the recording medium by changing the wavelengths of the signal light beam and the reference light beam.

As described above, in the digital holographic storage, high-speed transfer by the two-dimensional batch recording and reproducing method and the increase in the capacity by the volume recording can be realized at the same time.

Photopolymer materials, photorefractive materials, photochromic materials such as azopolymer materials, and the like are actively researched and developed as a material of the recording medium. Among them, the photorefractive materials and the photochromic materials such as azopolymer materials are rewritable. In the case where the rewritable type material is used, the recorded data can be erased and the new data can be recorded. Since the rewritable type medium can be repeatedly utilized, in addition to the information storage for the large capacity, it is largely expected that the rewritable type medium may be utilized as a backup memory for the hard disk drive or the like. A rewrite function is not required because the rewriting can not be performed in a write-once type holographic memory (writable only once).

On the other hand, in the rewritable holographic memory, it is necessary to be capable of rewriting the data at high speed and to obtain the reproduced light beam with low noise and high SN ratio. In the case where the recorded data is erased in order to rewrite the data, most commonly, the recorded hologram is erased by irradiating the whole recording region with uniform light. In the photorefractive materials and the photochromic materials such as azopolymer materials, the hologram can be also erased at once by retaining the recording medium at a high temperature.

In the case where the recorded data is erased, two processes of an erasing process and a recording process are required when the new information is written after the entire information is erased, so that long time is required in the case of the recording medium having the large capacity more than 100 GB, for example. Therefore, in the shift multiplexing method, it is practically desirable to erase the unnecessary data, without performing the erasing process, by irradiating the same position as the recording position of each page of the hologram which is already recorded with the signal light beam and reference light beam, which have the same polarization state as the state in recording the hologram which has been already recorded, and writing a new hologram.

However, even if the new hologram overwrites the already recorded hologram, the already recorded hologram can not be completely erased, so that there is the problem that quality of the reproduced light beam is degraded by mixing diffraction light beams from both the already recorded hologram and the newly recorded hologram, when the new hologram which overwrote the hologram which had been already recorded is reproduced.

The invention is achieved for solving the above-mentioned problem. It is an object of the invention to provide a hologram recording method and a hologram recording apparatus which provide good quality of the reproduced light and can rewrite and record data at high speed without performing the erasing process.

### SUMMARY OF THE INVENTION

In order to achieve the above-mentioned object, one aspect of the invention is to provide a hologram recording method, in which information of a signal light beam is multiple-recorded as a hologram of a plurality of pages in an optical recording medium by irradiating the optical recording medium with the signal light beam and a reference light beam at the same time and by changing a recording angle while changing an angle formed between the signal light beam and the reference light beam (angular multiplexing method), wherein each page of the hologram is newly recorded at a recording angle different from a recording angle of each page of a hologram previously recorded in the optical recording medium.

Another aspect of the invention is to provide a hologram recording method, in which information of a signal light beam is multiple-recorded as a hologram of a plurality of pages in an optical recording medium, in such a manner that a recording position is changed by irradiating the optical recording medium with the signal light beam and a reference light beam at the same time while making an angle formed between the signal light beam and the reference light beam a constant value and relatively moving at least one of (A) the signal light beam and the reference light beam, and (B) the optical recording medium (shift multiplexing method), wherein each page of the hologram is newly recorded at a recording position different from a recording position of each page of a hologram previously recorded in the optical recording medium.

Still another aspect of the invention is to provide a hologram recording method, in which information of a signal light beam is multiple-recorded as a hologram of a plurality of pages in an optical recording medium, in such a manner that an angle formed between a signal light beam and a reference light beam is made a constant value and the optical recording medium is irradiated with the signal light beam and the reference light beam at the same time while changing wavelengths of the signal light beam and the reference light beam (wavelength multiplexing method), wherein each page of the hologram is newly recorded by using the signal light beam and the reference light beam, which have the wavelength different from wavelengths at the time of recording each page of a hologram previously recorded in the optical recording medium.

In each of the above aspects of the invention, without performing an erasing process, each page of the hologram is newly recorded on the condition different from the condition of the case where each page of the already recorded hologram was recorded, so that the quality of the reproduced light beam becomes better and the rewriting and recording can be performed at high speed.

It is effective that the recording angle at which each page of the hologram of the angular multiplexing method is newly recorded is an angle at which light beam intensity of a reproduced light beam from each page of the hologram previously recorded in the optical recording medium is minimized. It is effective that the recording position where each page of the hologram of the shift multiplexing method is newly recorded is a position where light beam intensity of a reproduced light beam from each page of the hologram previously recorded in the optical recording medium is minimized. In the wavelength multiplexing method, it is effective that each page of the hologram is newly recorded by using the signal light beam and the reference light beam, which have wavelengths at which light beam intensity of a reproduced light beam from each page of the hologram previously recorded in the optical recording medium is minimized.

That is to say, the condition in which the light beam intensity of the reproduced light beam from each page of the hologram recorded in the optical recording medium is minimized is out of Bragg condition of the reproduced light beam from each page of the hologram recorded in the optical recording medium. For this reason, by performing the recording in the above-mentioned way, the Bragg condition of the reproduced light beam from each page of the hologram previously recorded in the optical recording medium does not correspond to the Bragg condition of the reproduced light beam from each page of the hologram which is newly recorded. Accordingly, the reproduced light beam from each page of the hologram which had been previously recorded is not mixed with the reproduced light beam from each page of the hologram which was newly recorded at the time of reproducing each page of the hologram which was newly recorded, and the hologram can be reproduced with high quality.

In each of the above aspects of the invention, it is more preferable that a polarization state of the signal light beam or the reference light beam at the time of newly recording each page of the hologram is caused to be different from a polarization state of the signal light beam or the reference light beam at the time of recording each page of the hologram previously recorded in the optical recording medium. In order to obtain the different polarization conditions, for example, a polarization direction of the signal light beam and a polarization direction of the reference light beam at the time of newly recording each page of the hologram may be caused to be orthogonal to each other when a polarization direction of the signal light beam and a polarization direction of the reference light beam at the time of recording each page of the hologram previously recorded in the optical recording medium are parallel to each other, and the polarization direction of the signal light beam and the polarization direction of the reference light beam at the time of newly recording each page of the hologram may be caused to be parallel to each other when the polarization direction of the signal light beam and the polarization direction of the reference light beam at the time of recording each page of the hologram previously recorded in the optical recording medium are orthogonal to each other.

If the polarization state of the case where each page of the hologram which has been already recorded is recorded is caused to be different from the polarization condition of the case where each page of the hologram is newly recorded, the reproduced light beam from each page of the hologram which had been already recorded is not mixed with the reproduced light beam from each page of the hologram which was newly recorded in reproducing each page of the hologram which was newly recorded, and the hologram can be reproduced with high quality.

Materials including a photorefractive material, a photochromic material and a polarization sensitive material can be used as the optical recording medium. It is preferable that the polarization sensitive material is at least one kind of polymer selected from polyesters and has an azobenzene structure in a side chain.

Another aspect of the invention is to provide a hologram recording apparatus, in which information of a signal light beam is multiple-recorded as a hologram of a plurality of pages in an optical recording medium by using the above-mentioned hologram recording methods.

A hologram recording apparatus in which the shift multiplexing method is applied, can include a light source for emitting a coherent light beam, a stage which rotates or moves the optical recording medium, a light beam separating optical path changing device which changes an optical path so that the optical recording medium is irradiated with a reference light beam and a signal light beam at the same time after the coherent light beam is separated into a light beam for the reference light beam and a light beam for the signal light beam, a spatial light modulator which is arranged on the optical path of the light beam for the signal light beam, and modulates the light beam for the signal light beam according to a supplied recording signal for each page so as to generate a signal light beam for recording each page of a hologram, and a signal supplying device which supplies the recording signal for each page to the spatial light modulator so that each page of the hologram is recorded at a position where a maximum point of light beam intensity of a reproduced light beam is shifted by a predetermined amount when each page of the recorded hologram is reproduced, and newly supplies the recording signal for each page to the spatial light modulator so that each page of the hologram is newly recorded at a recording position which is different from a recording position of each page of a hologram previously recorded in the optical recording medium.

The recording position where each page of the hologram is newly recorded can be a position where a light beam intensity of a reproduced light beam from each page of the hologram previously recorded in the optical recording medium is minimized as mentioned above.

The hologram recording apparatus can be provided with an analyzer which transmits a component, in a predetermined polarization direction, of a diffraction light beam from each page of the hologram recorded in the optical recording medium, and a detector which detects intensities of transmitted light beams that are transmitted through the analyzer. The necessary component can be selected and reproduced by providing the analyzer.

In the hologram recording apparatus, it is effective that a polarization state of the signal light beam or the reference light beam at the time of newly recording each page of the hologram is caused to be different from a polarization state of the signal light beam or the reference light beam at the time of recording each page of the hologram previously recorded in the optical recording medium.

In order to obtain the different polarization states, a polarization direction of the signal light beam and a polarization direction of the reference light beam at the time of newly recording each page of the hologram may be caused to be orthogonal to each other when a polarization direction of the signal light beam and a polarization direction of the reference light beam at the time of recording each page of the hologram previously recorded in the optical recording medium are parallel to each other, and the polarization direction of the signal light beam and the polarization direction of the reference light beam at the time of newly recording each page of the hologram may be caused to be parallel to each other when the polarization direction of the signal light beam and the polarization direction of the reference light beam at the time of recording each page of the hologram previously recorded in the optical recording medium are orthogonal to each other.

### BRIEF DESCRIPTION OF THE DRAWINGS

FIG. 1 is a schematic view of a hologram recording and reproducing apparatus of the embodiment.

FIG. 2A is a schematic view showing a structure of a hologram recording medium.

FIG. 2B is a schematic view showing the structure of the hologram recording medium.

FIG. 2C is a schematic view showing the structure of the hologram recording medium.

FIG. 3 is a schematic view showing a relationship between a signal light irradiating region and a reference light irradiating region.

FIG. 4 is a flow chart showing a hologram recording and reproducing processing routine of the embodiment.

FIG. 5 is a diagram showing a relationship between diffraction light beam intensity from a data page of a hologram which has been recorded and diffraction light beam intensity from the data page of the hologram which is newly recorded.

FIG. 6 is a view explaining an angular multiplexing method which is one of hologram multiplexing methods.

FIG. 7A is a view explaining a shift multiplexing method.

FIG. 7B is a view explaining the shift multiplexing method.

### DETAILED DESCRIPTION OF THE INVENTION

With Reference to the accompanying drawings, the hologram recording and reproducing apparatus according to an embodiment of the present invention will be described in detail below. The hologram recording and reproducing apparatus of the embodiment is one to which the shift multiplexing method of the invention is applied.

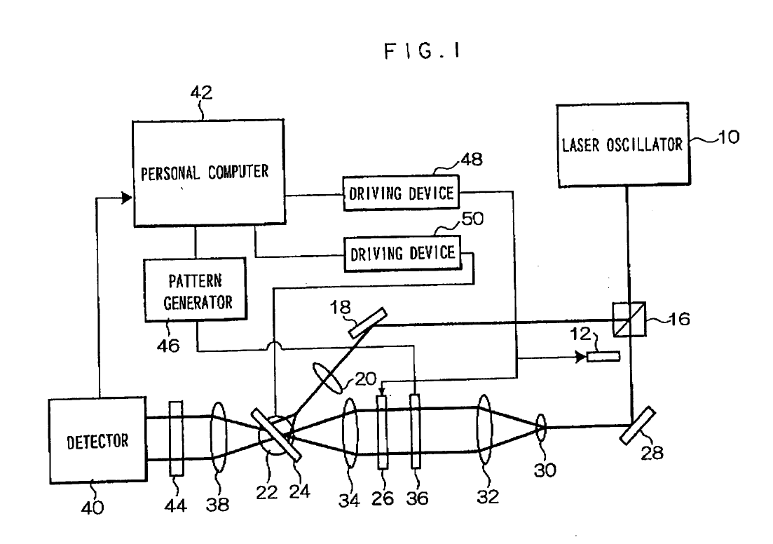

As shown in FIG. 1, a laser oscillator 10 using a Nd:YVO₄ crystal, for example, is provided in the hologram recording and reproducing apparatus of the embodiment. Laser oscillation occurs in the laser oscillator 10, and a laser beam which is a coherent light beam having a wavelength of 532 nm is radiated from the laser oscillator 10.

A polarizing beamsplitter 16 is arranged on a laser beam irradiating side of the laser oscillator 10. The polarizing beamsplitter 16 separates the laser beam into two light beams of a light beam for a reference light beam and a light beam for a signal light beam in such a manner that the polarizing beamsplitter transmits P-polarized light and reflects S-polarized light.

A reflecting mirror 18 which reflects the laser beam for the reference light beam to change an optical path toward a direction of the hologram recording medium, and an objective lens 20 which condenses the laser beam for the reference light beam to generate the reference light beam including a spherical reference wave, are arranged in this order on a light reflection side of the polarizing beamsplitter 16. An x-z stage 22 is provided on a laser beam condensing side of the objective lens 20. The x-z stage 22 includes a stepping motor rotating a hologram recording medium 24 formed in the shape of a disk in a z-plane. The hologram recording medium 24 is irradiated with the s-polarized light beam which is the spherical reference wave, as the reference light beam through the objective lens 20.

A shutter 12 interrupting the P-polarized light beam transmitted through the polarizing beamsplitter 16 is arranged on a light beam transmission side of the polarizing beamsplitter 16 so that the shutter 12 can be inserted into and retracted from the optical path. Further, a reflecting mirror 28 which reflects the laser beam for signal light beam at a reflection angle of 45° to change the optical path toward the direction of the hologram recording medium, and a lens system including lenses 30, 32, and 34 are arranged in this order on the light beam transmission side of the polarizing beamsplitter 16. A transmission type of spatial light modulator 36 is arranged between the lens 32 and the lens 34. The spatial light modulator 36 includes a liquid crystal display device and the like and modulates the laser beam for the signal light beam according to a supplied recording signal in each page to generate the signal light beam for recording each page of the hologram. A polarization rotator 26 for rotating a polarization plane of light by 90° is arranged on a light beam transmission side of the spatial light modulator 36 so that the polarization rotator 26 can be inserted into and retracted from the optical path. The spatial light modulator 36 emits a S-polarized light beam when a P-polarized light beam is incident thereto. A polarization rotator 26 is arranged on the light beam transmission side of the spatial light modulator 36, and the polarization rotator 26 emits a P-polarized light beam when a S-polarized light beam is incident thereto.

The lenses 30 and 32 collimate the laser beam to form the light beam having a larger diameter, and the spatial light modulator 36 is irradiated with the light beam. The lens 34 condenses the P-polarized light beam which has been modulated and transmitted by the spatial light modulator 36 and the polarization rotator 26, on the hologram recording medium 24 for the purpose of the signal light beam. At this point, the spot of the signal light beam is condensed so as to be smaller than the condensed spot of the reference light beam, and the hologram recording medium 24 is simultaneously irradiated with the signal light beam and the reference light beam. Since the P-polarized light beam is set to the signal light beam and the s-polarized light beam is set to the reference light beam, the polarization direction of the signal light beam is orthogonal to the polarization direction of the reference light beam in recording each page of the hologram. The S-polarized light beam may be set to the signal light beam and the P-polarized light beam may be set to the reference light beam, the signal light beam and reference light beam whose polarization planes are parallel to each other may be used, and circularly polarized light beams which are rotated in directions different from each other may be used as the signal light beam and reference light beam.

A lens 38, an analyzer 44 which selects the light beam in a predetermined polarization direction (for example, 0° polarized component, 45° polarized component, or 90° polarized component) from the reproduced light beams and transmits the selected light beam, and a detector 40 which includes an imaging device such as CCD and converts the received reproduced light beam into an electric signal to output the light beam, are arranged on a reproduced light beam transmission Bide of the hologram recording medium 24. The detector 40 is connected to a personal computer 42.

The personal computer 42 is connected to the spatial light modulator 36 through a pattern generator 46 which generates a pattern according to the recording signal supplied from the personal computer 42 at predetermined timing. The personal computer 42 is connected to a driving device 48. While the driving device 48 drives the shutter 12 and the polarization rotator 26 so as to be separately inserted into the optical path, the driving device 48 retracts separately the shutter 12 and the polarization rotator 26, which are inserted in the optical path, from the optical path. Further, the personal computer 42 is connected to a driving device 50 which drives the x-z stage 22.

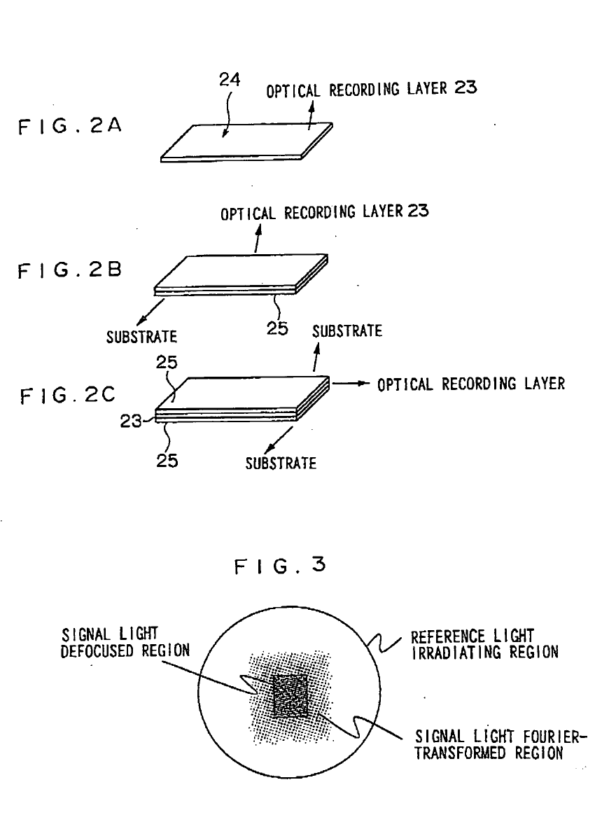

FIG. 2 shows a structure of the hologram recording medium (optical recording medium) 24. The hologram recording medium of the embodiment is formed in the shape of the disk, and FIG. 2 shows a part taken in the rectangular shape. As shown in FIG. 2A, the hologram recording medium 24 includes an optical recording layer 23 molded in the form of a thick film having a thickness not lower than 100 μm, for example. In the case where the optical recording layer itself does not have sufficient strength, as shown in FIG. 2B or FIG. 2C, a substrate 25 formed of a plate-shaped transparent medium such as quartz or plastic is provided on one side or both sides of the optical recording layer.

Any material can be used for the optical recording layer, namely for the photosensitive layer as long as the material is a photorefractive material, a photochromic material or a polarization sensitive material, which has photoinduced refractive index change or photoinduced dichroism and holds them at room temperature. In particular, the material which is macromolecule containing a photoisomerizing group in its side chain, e.g., the material which is at least one kind of a polymer selected from polyesters and contains the photoisomerizing group in the side chain such as an azobenzene structure, is preferable for the optical recording layer.

A principle of photoinduced birefringence will be described below taking azobenzene as an example. Azobenzene repeats an isomerization cycle of trans-cis-trans by light beam irradiation. The multiplicity of trans-azobenzene molecules is present in the optical recording layer before the light beam irradiation. These molecules are randomly oriented and macroscopically isotropic. When the azobenzene molecule is irradiated with linearly polarized light beam, the azobenzene molecule having an absorption axis in the same direction as the polarized direction is selectively isomerized from trans to cis. The molecule having the absorption axis in the direction orthogonal to the polarized direction, which has been relaxed in the trans-form, no longer absorbs the light and is fixed at the state. As a result, macroscopic anisotropies of an absorption coefficient and a refractive index, namely the dichroism and the birefringence are induced. In the macromolecule including the photoisomerizing group, the orientation of the macromolecule itself is changed by the photoisomerization and the large birefringence can be induced. The birefringence induced in the above-mentioned way is stable at temperatures not more than a glass transition temperature, and it is preferable to record each page of the hologram.

Polyester having cyanoazobenzene in the side chain represented by the following chemical formula (Japanese Patent Application Laid-Open (JP-A) No. 10-340479) is preferable for the material for recording the hologram by utilizing the above-mentioned mechanism. In this polyester, resulting from the photoinduced anisotropy caused by the photoisomerization of cyanoazobenzene in the side chain, the polarization direction of the signal light beam can be recorded as the hologram, and the hologram can be recorded at room temperature and the recorded hologram can be retained semipermanently.

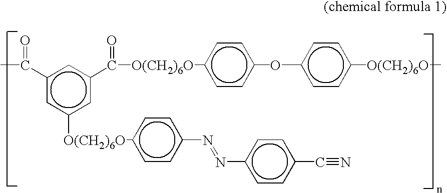

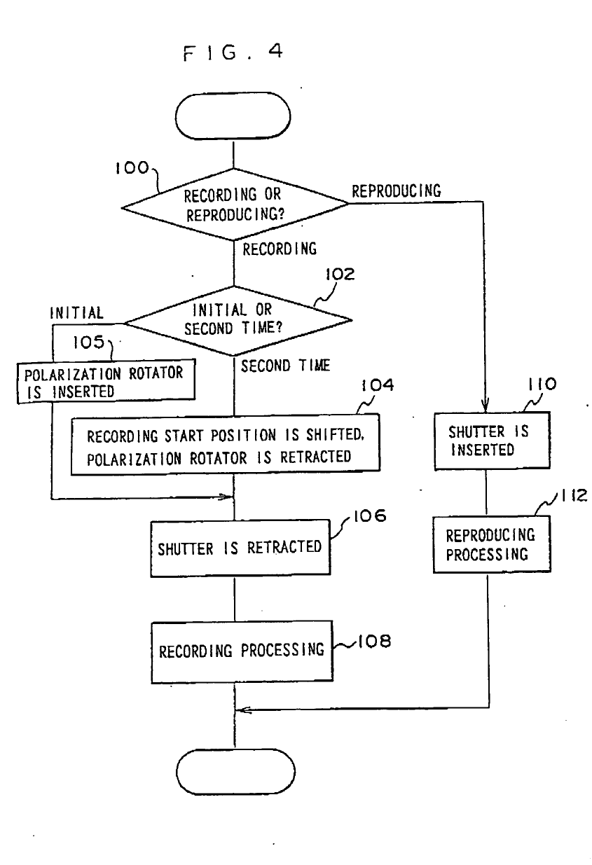

Referring to FIG. 4, a recording and reproducing processing routine executed by the personal computer 42 will be described below. At first an operator operates an operating device (not shown) to select recording processing of each page of the hologram or reproducing processing of the hologram. In the case where each page of the hologram is recorded, recording information is previously inputted into the personal computer to generate the recording signal.

In step 100, a determination is made whether the recording processing of each page of the hologram has been selected or the reproducing processing of the hologram has been selected. If the recording processing of each page of the hologram has been selected, in step 102, a determination is made whether the recording is performed to the hologram recording medium in which no hologram has been recorded yet (the initial recording processing of the hologram) or the recording of each page of the hologram is newly recorded to the hologram recording medium in which the hologram has been already recorded (second-time recording processing of the hologram).

Whether the recording of the hologram is the second-time recording processing or not can be decided by, for example, irradiating, as described later, the hologram recording medium with the reproduced light beam to read the number of writing times which is previously recorded in the hologram recording medium. Alternately, an operator directs to the hologram recording and reproducing apparatus whether the recording of hologram is the initial recording processing or the second-time recording processing at the time of recording, and a determination can be made on the basis of the direction.

In the case of the initial recording processing of the hologram, in steps 105 and 106, while the polarization rotator 26 is inserted into the optical path and the shutter 12 is retracted from the optical path so that the laser beam can pass therethrough by driving the driving device 48, the driving device 50 drives the stepping motor of the x-z stage 22 to rotate the hologram recording medium at a predetermined rotational speed.

In next step 108, while the hologram recording medium is irradiated with the laser beam, the personal computer 42 outputs the recording signal of each page from a recording start position at predetermined timing, and the shift multiplexing processing of the hologram is executed to the hologram recording medium.

In the shift multiplexing method of the embodiment, the spherical wave is used as the reference light beam, the hologram recording material is formed in the shape of the disk, and the shift multiplexing is performed by rotating the disk-shaped hologram recording medium (disk). In the shift multiplexing method, the holograms of the plurality of pages can be recorded by the rotation of the disk, with the holograms of the plurality of pages overlaid at the same region. When the wavelength of the laser beam, the film thickness of the recording medium, NA of the objective lens, and the like are properly set, the hologram of the next page can be recorded and reproduced in substantially the same region of the disk without crosstalk between the next page and the page which has been already recorded, only by rotating the disk so that the recording position is shifted by several tens μm in order to record the hologram of the next page. This takes advantage of the fact that the shift of the disk-shaped hologram recording medium (the shift by several tens μm) is equivalent to a change in an angle of the reference light beam, since the reference light beam is the spherical wave.

A distance which defines the amount of shift of the disk-shaped hologram recording medium of the shift multiplexing using the spherical reference wave, that is, the distance δ_{spherical} in which each hologram can be independently separated is given by the following equation (1).

$${δ}_{spherical} = {δ}_{Bragg} + {δ}_{NA} = \frac{λ {z}_{0}}{L tan {θ}_{s}} + \frac{λ}{2 ( NA )} \qquad ( 1 )$$

Where λ is the wavelength of the laser beam, zₒ is the distance between the objective lens generating the spherical reference wave and the hologram recording medium, L is the film thickness of the hologram recording medium, NA is numerical aperture of the objective lens, and θ_{δ} is the angle between the signal light beam and the reference light beam. As the film thickness L of the hologram recording medium becomes larger, the amount of shift δ defined according to the distance in which each hologram can be independently separated becomes smaller according to the equation (1). Accordingly, the number of multiplexed holograms can be increased and the recording capacity can be also increased.

The personal computer supplies the recording signal of each page to the spatial light modulator at timing defined so that each page of the hologram is recorded from the recording start position at an interval of the mount of shift δ, while the hologram recording medium is being rotated.

In the embodiment, similarly to the typical digital holographic storage, the signal light beam is Fourier transformed with the lens and the hologram recording medium is irradiated with the Fourier-transformed signal light beam. Relatively strong light intensity can be obtained at the surface of the hologram recording medium by using the lens. When the distance between the Fourier-transform lens and the hologram recording medium is equal to a focal length of the lens, Fourier-transformed hologram is recorded. Generally the hologram recording is performed while slightly shifting the recording medium from a focal point of the lens in order to suppress the intensity of zero-order diffraction light beam of the signal light beam on the recording surface.

FIG. 3 schematically shows a state of a defocused position during the hologram recording. The signal light beam is condensed at a certain extent with the lens and a diffraction pattern of a data page appears on the hologram recording medium. The diffraction pattern corresponds to a pattern (periodicity) of the digital data page and has the largest spread when the digital data page has a random pattern.

The region wider than that of the diffraction pattern of the signal light beam is irradiated with the reference light beam so that the reference light beam covers the entire diffraction patterns of the signal light beam. The change in refractive index or the absorption is generated at the position where the light beam is strengthened by interference between the signal light beam and the reference light beam, and the change is little at the position where the light beam is weakened. This phenomenon causes each page of the hologram to be recorded.

In the case where the determination is made that the hologram recording is second time by reading the number of writing times and the like in step 102, in step 104, while the recording start position of the initial page of the hologram is shifted by a predetermined amount from the recording start position of the hologram which has been already recorded, the polarization rotator 26 is retracted from the optical path and, as described above, the second-time recording processing of the hologram is executed with the amount of shift δ.

The shifted amount of the recording start position of the initial page of the hologram is preferable to a half of the amount of shift δ in recording each page. After the recording start position of the initial page of the hologram is shifted, the hologram recording is performed with the amount of shift δ in the same way as described above. Accordingly, each page of the hologram is newly recorded at a recording position different from the recording position where the each page of the hologram has been already recorded.

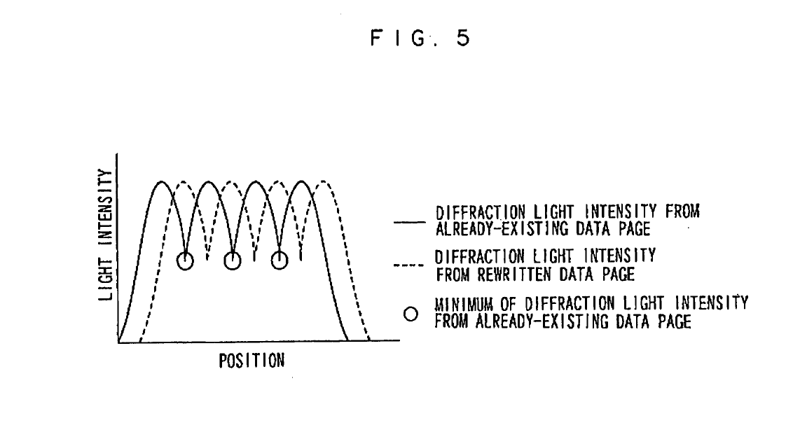

FIG. 5 shows four pages of the relationship between diffraction light beam intensity during reproducing from the data page of the hologram which has been already recorded and the diffraction light beam intensity during reproducing from the data page of the hologram which is newly recorded in the hologram recording medium. Since the recording start position of the initial page is shifted beforehand by the half of the amount of shift δ, each data page of the hologram which is newly recorded is recorded so that a maximum point of the diffraction light beam intensity is located at the position where the diffraction light beam intensity from the data page of the hologram which has been already recorded in the hologram recording medium becomes minimum. Since the position where the diffraction light beam intensity from the data page of the hologram which has been already recorded becomes minimum is one which is out of the Bragg condition of the data page, the crosstalk during the recording and reproducing is eliminated by newly recording each page of the hologram at the position where the diffraction light beam intensity becomes minimum.

In performing the second-time recording of the hologram, the polarization rotator 26 is retracted, and thus a polarization direction of the signal light beam for recording each page of the hologram is parallel to the polarization direction of the reference light beam, so that a polarization state of the signal light beam used for recording each page of the hologram which has been already recorded is different from the polarization state of the signal light beam used for recording each page of the hologram which is newly recorded.

The example in which the polarization state is changed by rotating the polarization plane of the signal light beam was described in the embodiment. However, the polarization state may be changed by rotating the polarization plane of the reference light beam. In this case, the polarization rotator which is the same as described above is arranged on the light beam reflection side of the polarization beamsplitter while the polarization rotator can be inserted into the optical path and retracted from the optical path.

The example in which each page of the initial hologram is recorded while the polarization rotator 26 is inserted into the optical path and each page of the second-time hologram is recorded while the polarization rotator 26 is retracted from the optical path was described in the embodiment. On the other hand, each page of the initial hologram may be recorded while the polarization rotator 26 is retracted from the optical path and each page of the second-time hologram may be recorded while the polarization rotator 26 is inserted into the optical path.

The reproducing processing of the hologram will be described below. If the determination is made that the reproducing processing of the hologram is selected in step 100, the shutter 12 is inserted into the optical path in step 110. This allows the shutter 12 to interrupt the laser beam transmitted through the polarization beamsplitter 16, so that the hologram recording medium in which the hologram has been recorded is irradiated only with the reference light beam. The reproduced light beam diffracted in the hologram recording medium is transmitted through the lens 38, only the reproduced light beam having a predetermined polarization component is selectively transmitted through the analyzer 44, the reproduced light beam received by the detector 40 is converted into an electric signal by the detector 40 to be inputted to the personal computer 42, and the electric signal is displayed on a screen provided in the personal computer 42.

In the embodiment, the example in which the shift multiplexing is performed by rotating the hologram recording medium was described above. However, the shift multiplexing may be performed by linearly moving the hologram recording medium, and the hologram recording medium may be scanned by the signal light beam and the reference light beam instead of rotating or linearly moving the hologram recording medium.

Though the embodiment in which the shift multiplexing method is adopted was described above, the invention can be applied to an angular multiplexing method or a wavelength multiplexing method.

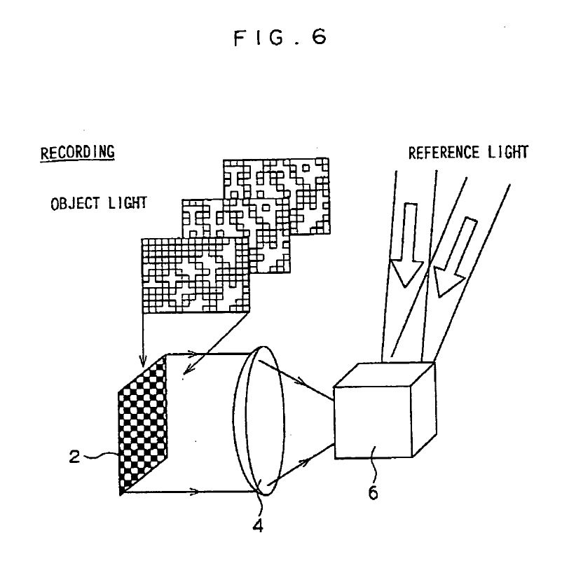

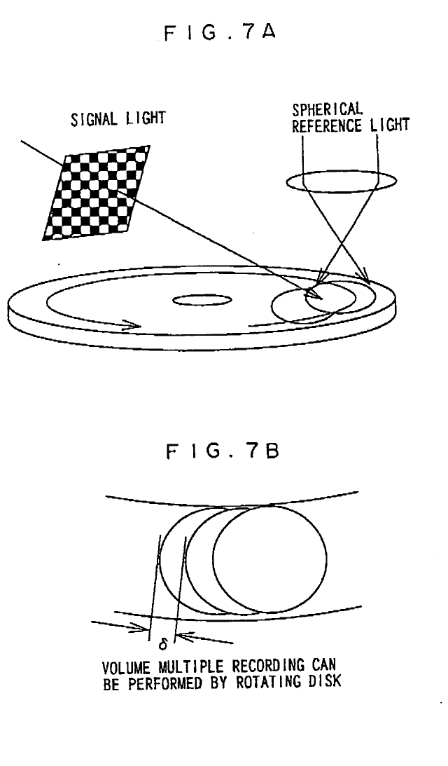

In the case where the invention is applied to the angular multiplexing method, as shown in FIG. 6, in the initial hologram recording, while the angle formed by the reference light beam relative to the signal light beam is varied by the predetermined angle θ, a recording angle is changed by simultaneously irradiating the optical recording medium with the signal light beam and the reference light beam, and information of the signal light beam is multiple-recorded as the hologram of the plurality of pages in the hologram recording medium.

In the case where each page of the hologram is newly recorded in the recorded hologram recording medium, after the recording start position is shifted by θ/2, while the angle formed by the reference light beam relative to the signal light beam is varied by the predetermined angle θ, each page of the hologram is recorded in the same way as the initial recording. Accordingly, each page of the hologram is newly recorded at the recording angle different from the recording angle of each page of the hologram which has been already recorded. The angle of the reference light beam for newly recording each page of the hologram is one which is equal to the angle, at which the light beam intensity of the reproduced light beam from each page of the hologram recorded in the holographic recording medium is minimized. As described in the shift multiplexing method, the angle at which the diffraction light beam intensity from the data page of the already recorded hologram is minimized is also one which is out of the Bragg condition of the data page.

Though the example in which the multiplexing is performed by changing the angle of the reference light beam was described above, the multiplexing may be performed by changing the angle of the signal light beam relative to the reference light beam.

In the case where the invention is applied to the wavelength multiplexing method, in the initial hologram recording, the angle formed between the signal light beam and the reference light beam is made constant, and while the wavelengths of the signal light beam and the reference light beam are varied by the predetermined wavelength Δλ, the optical recording medium is simultaneously irradiated with the signal light beam and the reference light beam, and the information of the signal light beam is multiple-recorded as the hologram of the plurality of pages in the holographic recording medium.

In the case where each page of the hologram is newly recorded in the recorded hologram recording medium, after the wavelengths of the signal light beam and the reference light beam of the recording start are shifted by Δλ/2, while the wavelengths of the signal light beam and the reference light beam are varied by Δλ, each page of the hologram is recorded in the same way as the initial recording. Accordingly, each page of the hologram is newly recorded at the wavelengths of the signal light beam and the reference light beam different from the wavelengths used for recording each page of the hologram which has been already recorded. The wavelengths of the signal light beam and the reference light beam which newly record each page of the hologram are those which are equal to the wavelengths in which the light beam intensity of the reproduced light beam from each page of the hologram recorded in the holographic recording medium becomes the minimum. As described in the shift multiplexing method, the wavelength in which the diffraction light beam intensity from the data page of the recorded hologram becomes the minimum is also one which is out of the Bragg condition of the data page.

Both in the case where the invention is applied to the angular multiplexing method and in the case where the invention is applied to the wavelength multiplexing method, when the polarization direction of the signal light beam is parallel to the polarization direction of the reference light beam in recording each page of the hologram which is previously recorded in the recording medium, the polarization direction of the signal light beam is caused to be orthogonal to the polarization direction of the reference light beam in newly recording each page of the hologram. When the polarization direction of the signal light beam is orthogonal to the polarization direction of the reference light beam in recording each page of the hologram which is previously recorded in the recording medium, the polarization direction of the signal light beam is caused to be parallel to the polarization direction of the reference light beam in newly recording each page of the hologram. Further, it is preferable that the polarization state of the signal light beam or the reference light beam in recording each page of the hologram which is already recorded in the recording medium is different from the polarization state of the signal light beam or the reference light beam at the time of newly recording each page of the hologram.

What is claimed is:

1. A hologram recording method comprising:
irradiating an optical recording medium with a signal light beam and a reference light beam at the same time; and
performing multiple recording of information of the signal light beam as a hologram of a plurality of pages in the optical recording medium by changing a recording angle while changing an angle formed between the signal light beam and the reference light beam,
wherein each page of the hologram is newly recorded at a recording angle different from a recording angle of each page of a hologram previously recorded in the optical recording medium.

2. A hologram recording method according to claim 1, wherein the recording angle at which each page of the hologram is recorded is an angle at which light beam intensity of a reproduced light beam from each page of the hologram previously recorded in the optical recording medium is minimized.

3. A hologram recording method according to claim 1, wherein a polarization state of the signal light beam or the reference light beam at the time of recording each page of the hologram is caused to be different from a polarization state of the signal light beam or the reference light beam at the time of recording each page of the hologram previously recorded in the optical recording medium.

4. A hologram recording method according to claim 3, wherein:
a polarization direction of the signal light beam and a polarization direction of the reference light beam at the time of newly recording each page of the hologram are caused to be orthogonal to each other when a polarization direction of the signal light beam and a polarization direction of the reference light beam at the time of recording each page of the hologram previously recorded in the optical recording medium are parallel to each other; and
the polarization direction of the signal light beam and the polarization direction of the reference light beam at the time of newly recording each page of the hologram are caused to be parallel to each other when the polarization direction of the signal light beam and the polarization direction of the reference light beam at the time of recording each page of the hologram previously recorded in the optical recording medium are orthogonal to each other.

5. A hologram recording method according to claim 1, wherein the optical recording medium comprises a photorefractive material.

6. A hologram recording method according to claim 1, wherein the optical recording medium comprises a photochromic material.

7. A hologram recording method according to claim 1, wherein the optical recording medium comprises a polarization sensitive material.

8. A hologram recording method according to claim 1, wherein the optical recording medium comprises at least one kind of polymer selected from polyesters.

9. A hologram recording method according to claim 8, wherein the at least one kind of polymer has an azobenzene structure in a side chain.

10. A hologram recording method comprising:
irradiating an optical recording medium with a signal light beam and a reference light beam at the same time while making an angle formed between the signal light beam and the reference light beam a constant value; and
performing multiple recording of information of the signal light beam as a hologram of a plurality of pages in the optical recording medium, in such a manner that a recording position is changed while relatively moving at least one of (A) the signal light beam and the reference light beam, and (B) the optical recording medium,
wherein each page of the hologram is newly recorded at a recording position different from a recording position of each page of a hologram previously recorded in the optical recording medium.

11. A hologram recording method according to claim 10, wherein the recording position where each page of the hologram is recorded is a position where light beam intensity of a reproduced light beam from each page of the hologram previously recorded in the optical recording medium is minimized.

12. A hologram recording method according to claim 10, wherein a polarization state of the signal light beam or the reference light beam at the time of recording each page of the hologram is caused to be different from a polarization state of the signal light beam or the reference light beam at the time of recording each page of the hologram previously recorded in the optical recording medium.

13. A hologram recording method according to claim 12, wherein:
a polarization direction of the signal light beam and a polarization direction of the reference light beam at the time of newly recording each page of the hologram are caused to be orthogonal to each other when a polarization direction of the signal light beam and a polarization direction of the reference light beam at the time of recording each page of the hologram previously recorded in the optical recording medium are parallel to each other; and
the polarization direction of the signal light beam and the polarization direction of the reference light beam at the time of newly recording each page of the hologram are caused to be parallel to each other when the polarization direction of the signal light beam and the polarization direction of the reference light beam at the time of recording each page of the hologram previously recorded in the optical recording medium are orthogonal to each other.

14. A hologram recording method according to claim 10, wherein the optical recording medium comprises a photorefractive material.

15. A hologram recording method according to claim 10, wherein the optical recording medium comprises a photochromic material.

16. A hologram recording method according to claim 10, wherein the optical recording medium comprises a polarization sensitive material.

17. A hologram recording method according to claim 10, wherein the optical recording medium comprises at least one kind of polymer selected from polyesters.

18. A hologram recording method according to claim 17, wherein the at least one kind of polymer has an azobenzene structure in a side chain.

19. A hologram recording method comprising:
irradiating an optical recording medium with a signal light beam and a reference light beam at the same time while changing wavelengths of the signal light beam and the reference light beam, in such a manner that an angle formed between the signal light beam and the reference light beam is made a constant value; and
performing multiple recording of information of the signal light beam as a hologram of a plurality of pages in the optical recording medium,
wherein each page of the hologram is newly recorded by using the signal light beam and the reference light beam, which have wavelengths different from wavelengths at the time of recording each page of a hologram previously recorded in the optical recording medium.

20. A hologram recording method according to claim 19, wherein each page of the hologram is recorded by using the signal light beam and the reference light beam, which have wavelengths at which light beam intensity of a reproduced light beam from each page of the hologram previously recorded in the optical recording medium is minimized.

21. A hologram recording method according to claim 19, wherein a polarization state of the signal light beam or the reference light beam at the time of recording each page of the hologram is caused to be different from a polarization state of the signal light beam or the reference light beam at the time of recording each page of the hologram previously recorded in the optical recording medium.

22. A hologram recording method according to claim 21, wherein:
a polarization direction of the signal light beam and a polarization direction of the reference light beam at the time of newly recording each page of the hologram are caused to be orthogonal to each other when a polarization direction of the signal light beam and a polarization direction of the reference light beam at the time of recording each page of the hologram previously recorded in the optical recording medium are parallel to each other; and
the polarization direction of the signal light beam and the polarization direction of the reference light beam at the time of newly recording each page of the hologram are caused to be parallel to each other when the polarization direction of the signal light beam and the polarization direction of the reference light beam at the time of recording each page of the hologram previously recorded in the optical recording medium are orthogonal to each other.

23. A hologram recording method according to claim 19, wherein the optical recording medium comprises a photorefractive material.

24. A hologram recording method according to claim 19, wherein the optical recording medium comprises a photochromic material.

25. A hologram recording method according to claim 19, wherein the optical recording medium comprises a polarization sensitive material.

26. A hologram recording method according to claim 19, wherein the optical recording medium comprises at least one kind of polymer selected from polyesters.

27. A hologram recording method according to claim 26, wherein the at least one kind of polymer has an azobenzene structure in a side chain.

28. A hologram recording apparatus which multiple-records information of a signal light beam as a hologram of a plurality of pages in an optical recording medium, wherein the hologram recording apparatus changes a recording angle by irradiating the optical recording medium with a signal light beam and a reference light beam at the same time while changing an angle formed between the signal light beam and the reference light beam, such that each page of the hologram is newly recorded at a recording angle different from a recording angle of each page of a hologram previously recorded in the optical recording medium.

29. A hologram recording apparatus which multiple-records information of a signal light beam as a hologram of a plurality of pages in an optical recording medium, wherein the hologram recording apparatus makes an angle formed between the signal light beam and a reference light beam a constant value and changes a recording position by irradiating the optical recording medium with the signal light beam and the reference light beam at the same time while relatively moving at least one of (A) the signal light beam and the reference light beam, and (B) the optical recording medium, such that each page of the hologram is newly recorded at a recording position different from a recording position of each page of a hologram previously recorded in the optical recording medium.

30. A hologram recording apparatus which multiple records information of a signal light beam as a hologram of a plurality of pages in an optical recording medium, wherein the hologram recording apparatus makes an angle formed between the signal light beam and a reference light beam a constant value and irradiates the optical recording medium with the signal light beam and the reference light beam at the same time while changing wavelengths of the signal light beam and the reference light beam, such that each page of the hologram is newly recorded by using the signal light beam and the reference light beam, which have wavelengths different from wavelengths at the time of recording each page of a hologram previously recorded in the optical recording medium.

31. A hologram recording apparatus comprising:
a light source for emitting a coherent light beam;
a stage which rotates or moves an optical recording medium;
a light beam separating optical path changing device which changes an optical path so that the optical recording medium is irradiated with a reference light beam and a signal light beam at the same time after the coherent light beam is separated into a light beam for the reference light beam and a light beam for the signal light beam;
a spatial light modulator which is arranged on the optical path of the light beam for the signal light beam, and modulates the light beam for the signal light beam according to a supplied recording signal for each page so as to generate a signal light beam for recording each page of a hologram; and
a signal supplying device which supplies the recording signal for each page to the spatial light modulator so that each page of the hologram is recorded at a position where a maximum point of light beam intensity of a reproduced light beam is shifted by a predetermined amount when each page of the recorded hologram is reproduced, and newly supplies the recording signal for each page to the spatial light modulator so that each page of the hologram is newly recorded at a recording position which is different from a recording position of each page of a hologram previously recorded in the optical recording medium.

32. A hologram recording apparatus according to claim 31, wherein the recording position where each page of the hologram is newly recorded is a position where a light beam intensity of a reproduced light beam from each page of the hologram previously recorded in the optical recording medium is minimized.

33. A hologram recording apparatus according to claim 31, further comprising:
an analyzer which transmits a component, in a predetermined polarization direction, of a diffraction light beam from each page of the hologram recorded in the optical recording medium; and
a detector which detects intensities of transmitted light beams that are transmitted through the analyzer.

34. A hologram recording apparatus according to claim 31, wherein a polarization state of the signal light beam or the reference light beam at the time of newly recording each page of the hologram is caused to be different from a polarization state of the signal light beam or the reference light beam at the time of recording each page of the hologram previously recorded in the optical recording medium.

35. A hologram recording apparatus according to claim 34, wherein:
a polarization direction of the signal light beam and a polarization direction of the reference light beam at the time of newly recording each page of the hologram are caused to be orthogonal to each other when a polarization direction of the signal light beam and a polarization direction of the reference light beam at the time of recording each page of the hologram previously recorded in the optical recording medium are parallel to each other; and
the polarization direction of the signal light beam and the polarization direction of the reference light beam at the time of newly recording each page of the hologram are caused to be parallel to each other when the polarization direction of the signal light beam and the polarization direction of the reference light beam at the time of recording each page of the hologram previously recorded in the optical recording medium are orthogonal to each other.
